(19) United States
(12) Patent Application Publication
(10) Pub. No.: US 2014/0019222 A1
(43) Pub. Date: Jan. 16, 2014

(54) COMBINING CREDIT CARD INFORMATION WITH PREFERRED PURCHASE INFORMATION

(71) Applicant: Leigh M. ROTHSCHILD, Sunny Isles Beach, FL (US)

(72) Inventor: Leigh M. ROTHSCHILD, Sunny Isles Beach, FL (US)

(73) Assignee: ARIEL INVENTIONS, LLC, Sunny Isles Beach, FL (US)

(21) Appl. No.: 13/548,728

(22) Filed: Jul. 13, 2012

(51) Int. Cl. G06Q 30/02

(52) U.S. Cl. 705/14.23

(57) ABSTRACT

The present disclosure provides systems and methods for processing purchases, including obtaining a payment account identifier for a purchase; transmitting the payment account identifier to a financial institution; receiving a rewards account identifier associated with the payment account identifier; and transacting the purchase using the payment account identifier. The systems and methods may include associating the purchase with the rewards account identifier and applying a benefit associated with the rewards account identifier to the purchase.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

Systems and methods for processing purchases, and in particular, to processing purchases and transactions involving rewards accounts and payment modalities.

### BACKGROUND OF THE INVENTION

Many merchants and vendors, whether they are online product providers or brick-and-mortar retail/service outlets, provide benefits or rewards to frequent customers. Such benefits or rewards are typically provided through a “rewards program” that tracks purchases through a unique account number or identifier attributed to a particular customer, and then provides some benefit to the customer once certain thresholds are met. Whenever goods or services are purchased, the customer must enter or present their “rewards program” account number so their purchases can be tracked and allocated towards the next perk or rewards threshold. For example, a customer may receive a monetary coupon or percentage discount once they have spent the requisite amount of money on the merchant's goods or services.

Though such rewards or discounts can provide a great benefit to the customer, a “rewards program” card is yet another item for customers to carry around along with their various credit cards, identification, licenses, and/or any other “rewards program” card they already have. Carrying such a myriad of cards and items increases the likelihood that a particular “rewards” card is lost, left at home, or simply not easily accessible when transacting a particular purchase that would qualify for the subscribed “rewards” program. Though many merchants have the capability to look up personal information in order to retrieve a particular “rewards” account number, this can prove difficult and undesirably time-consuming because many people have numerous phone numbers, work addresses and home addresses, etc. and may be unsure of which information is attributed to their “rewards” account.

### SUMMARY OF THE INVENTION

The present invention advantageously provides improved systems and methods for providing or retrieving “rewards” account information during a particular purchase or transaction. For example, in one embodiment, a method of processing a purchase is disclosed. The method includes obtaining a payment account identifier for a purchase. The payment account identifier is transmitted to a database, and a rewards account identifier associated with the payment account identifier is received from the database. The purchase is transacted using the payment account identifier. The method may include associating the purchase with the rewards account identifier, where associating the purchase with the rewards account identifier may include attributing a monetary amount of the purchase to the rewards account identifier. The method may include applying a benefit associated with the rewards account identifier to the purchase, where the benefit may include at least one of (a) a monetary discount or (b) a free good or service, for example. The method may include submitting the rewards account identifier to the financial institution and associating the rewards account identifier with the payment account identifier, where a merchant submits the rewards account identifier to the financial institution. The method may include submitting a plurality of rewards account identifiers to the financial institution for association with the payment account identifier and/or the payment account identifier may be obtained at a point of sale. The payment account identifier may include at least one of a credit card account number, a debit card account number or a checking account number.

In accordance with another embodiment, a purchase processing system is disclosed. The purchase processing system has a point of sale device having a processor configured to receive a payment account identifier for a purchase, cause the payment account to be transmitted to a financial institution, receive a rewards account identifier associated with the payment account identifier from the financial institution and transact the purchase using the payment account identifier and the rewards account identifier.

In accordance with another embodiment, a computer is disclosed. The computer has a storage device and a database stored in the storage device. The database contains a rewards account identifier associated with a payment account identifier.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a diagram of an example of a purchase processing system constructed in accordance with the principles of the present disclosure;

FIG. 2 is a diagram of another example of a purchase processing system constructed in accordance with the principles of the present disclosure;

FIG. 3 is a block diagram of an exemplary of a point of sale device constructed in accordance with the principles of the present disclosure;

FIG. 4 is a block diagram of a server constructed in accordance with the principles of the present disclosure; and

FIG. 5 is a flow chart of an exemplary rewards processing method in accordance with the principles of the present disclosure.

### DETAILED DESCRIPTION OF THE INVENTION

The present invention advantageously provides improved systems and methods for providing or retrieving “rewards” account information during a particular purchase or transaction. In a particular example, “rewards” account information is associated with a particular payment method or account, and when that payment method or account is used to transact goods or services form a merchant, the “rewards” account information is automatically retrieved and provided to the merchant. Identifying the “rewards” information associated with the payment method may be performed by a financial institution in conjunction with an approval of the method of payment or alternatively may be retrieved from a merchant's system independently of payment approval and authorization from a financial institution. Either way, a customer need not explicitly provide the “rewards” information during a transaction to ensure they receive the benefits of their rewards account.

Before describing exemplary embodiments in more detail, it is noted that the embodiments reside primarily in combinations of apparatus components and processing steps related to implementing a method, a system and a point of sale device for providing or retrieving “rewards” account information during a particular purchase or transaction. Accordingly, the method, system, and point of sale device components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

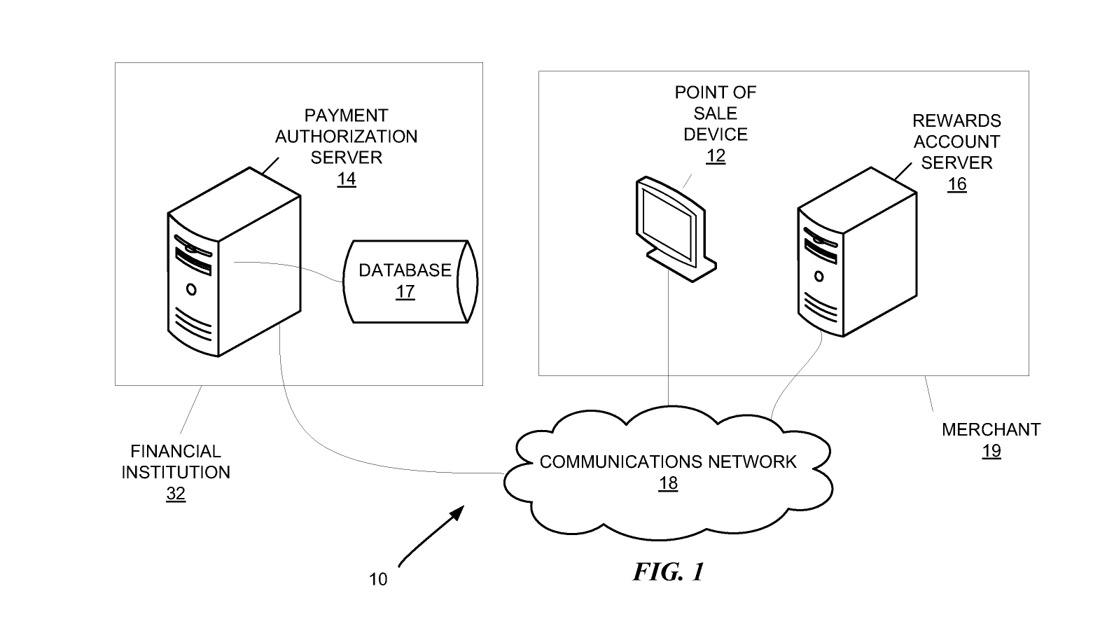

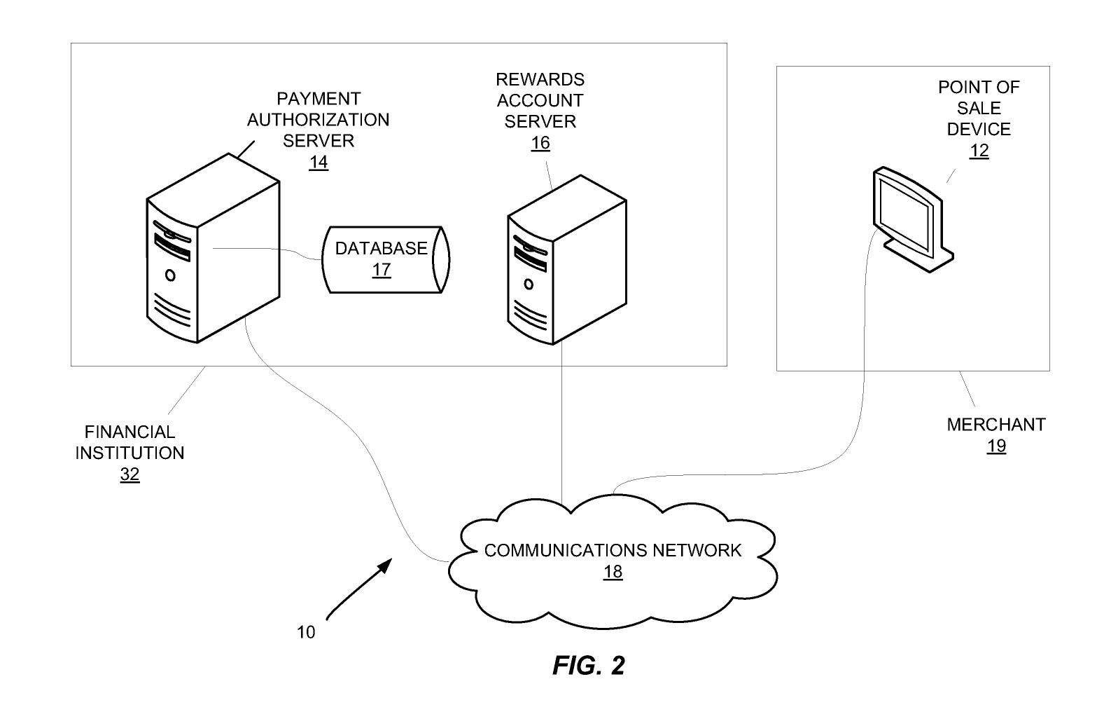

Referring now to the drawing figures in which reference designators refer to like elements, there is shown in FIGS. 1 and 2 a diagram of exemplary systems constructed in accordance with the principles of the present disclosure and designated generally as “10”. The system 10 may generally include a point of sale device 12, a payment authorization server 14, and/or a rewards account server 16. A database 17 containing one or more rewards account identifiers associated with respective payment account identifiers may be stored on the payment authorization server 14 and/or the rewards account server 16, as described in more detail herein. The point of sale device 12, payment authorization server 14, and/or rewards account server 16 may be connected to and/or in communication with one another through a communications network 18. The communications network 18 facilitates communication between two or more devices coupled to the network. Communication network 18 may include a cellular communication network and the Public Switched Telephone Network (PSTN), or other wide area network (WAN), such as the Internet, as well as local area networks (LANs), such as an Ethernet LAN. Communications network 18 may include a wireless network, such as Wi-Fi, satellite, infrared, Bluetooth, Near Field Communications, or other communications modalities.

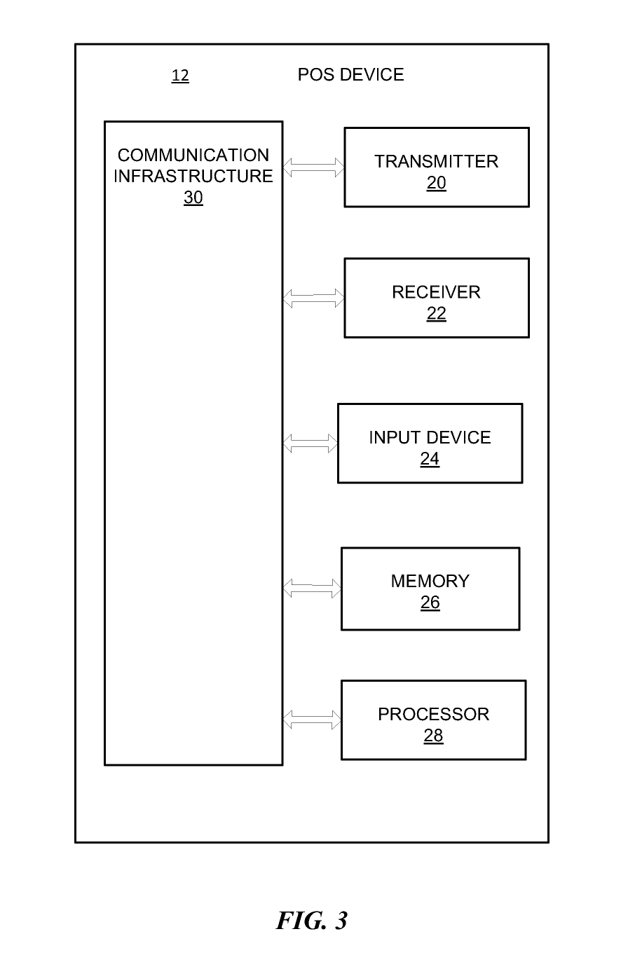

The point of sale device 12 may include any device configured to process a transaction between a customer and a merchant or vendor 19 offering goods or services to the customer. The point of sale device 12 may include, for example, a cash register, a self-service checkout terminal, an automated kiosk or vending machine, a website accessible through the internet, or the like. Now referring to FIG. 3, the point of sale device may generally include a transmitter 20, receiver 22, input device 24, memory 26, and processor 28, all connected via communication infrastructure 30. Communication infrastructure 30 may be a communications bus, cross-bar interconnect, network, etc. The point of sale device 12 may be positionable at a point of sale at a merchant's place of business and may be configured to receive a customer's payment information through the input device 24. The input device 24 may include, for example, a magnetic strip reader operable to read information from a credit or banking card, a keypad to enter account and/or pin numbers, and/or a radiofrequency signal reader that can communicate with a key fob or other signal transmitting customer identification device. For example, the input device 24 may utilize near field communications (“NFC”) to communicate with smartphones or other NFC equipped devices to receive payment information. The receiver 78 receives information (in computer readable code, for example) from the input device 24 as well as other components of the point of sale device itself (such as processor 28), and may further be in communication with other devices coupled to the point of sale device 12 through the network 18, such as the payment authorization server 14 and/or the rewards account server 16. The transmitter 20 may receive information from the receiver 22 and/or processor 28 and transmit the information through the communications network 18 to the payment authorization server 14 and/or the rewards account server 16.

The point of sale device may include a computer or communication device such as a tablet computer or smart phone arranged to communicate with a website of a merchant or financial institution. Accordingly, the input device may include a keyboard or touch screen on the device that allows a user to enter account and/or pin numbers that can be transmitted through the communications network 18 to the payment authorization server 14 and/or the rewards account server 16 as described herein.

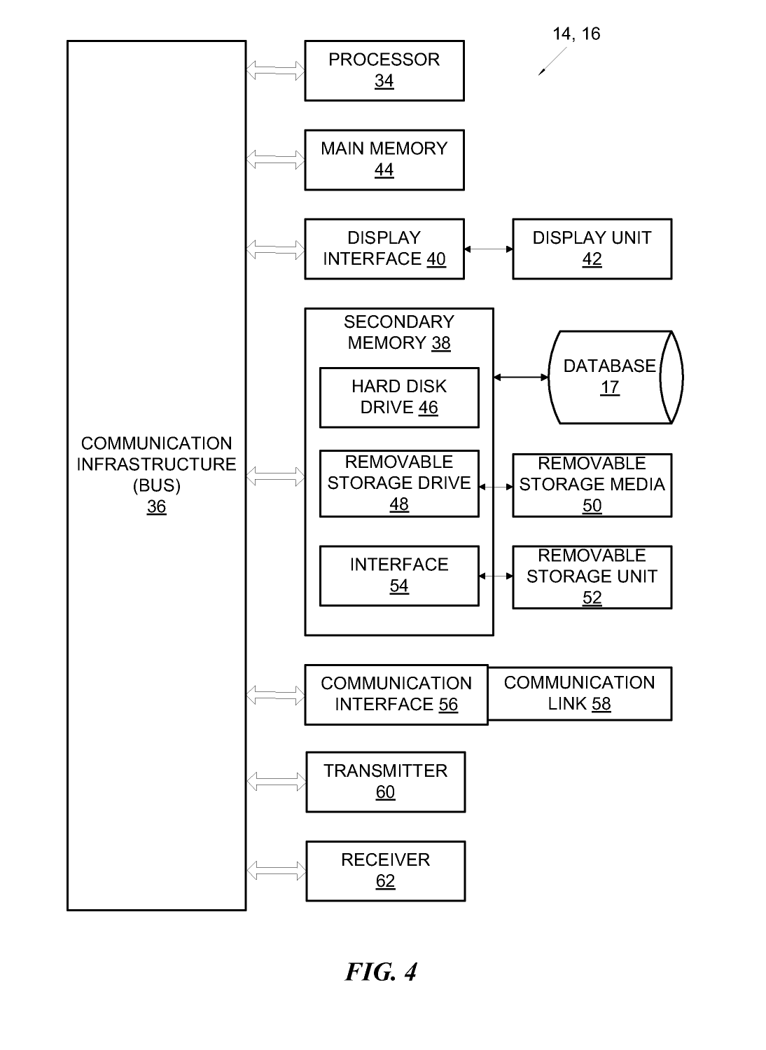

The payment authorization server 14 may be maintained or affiliated with a financial institution 32, such as a banking institution or a credit card company like Visa®, MasterCard®, or American Express® and may facilitate approval or authorization of a payment request received from a merchant regarding a customer having an account with the financial institution. The payment authorization server 14 may be in communication with the point of sale device 12 and/or the rewards account server 16 through the communications network 18. Now referring to FIG. 4, the payment authorization server 14 may generally include one or more processors, such as processor 34 programmed to perform the functions described herein. Processor 34 is operatively coupled to a communication infrastructure 36, e.g., a communications bus, cross-bar interconnect, network, etc. Processor 34 may execute computer programs stored on disk storage for execution via secondary memory 38. Various software embodiments are described in terms of this exemplary computer system. It is understood that computer systems and/or computer architectures other than those specifically described herein can be used to implement the invention. It is also understood that the capacities and quantities of the components of the architecture described below may vary depending on the device, the quantity of devices to be supported, as well as the intended interaction with the device. For example, configuration and management of the payment authorization server 14 may be designed to occur remotely by web browser. In such case, the inclusion of a display interface and display unit may not be required.

The payment authorization server 14 may optionally include or share a display interface 40 that forwards graphics, text, and other data from the communication infrastructure 36 (or from a frame buffer not shown) for display on the display unit 42. The computer system also includes a main memory 44, such as random access memory (“RAM”) and read only memory (“ROM”), and may also include secondary memory 38, either of which may include or constitute an electronic storage medium that stores the database 17. Secondary memory 38 may include, for example, a hard disk drive 46 and/or a removable storage drive 48, representing a removable hard disk drive, magnetic tape drive, an optical disk drive, etc. The removable storage drive 48 reads from and/or writes to a removable storage media 50 in a manner well known to those having ordinary skill in the art. Removable storage media 50, represents, for example, a floppy disk, external hard disk, magnetic tape, optical disk, etc. which is read by and written to by removable storage drive 48. As will be appreciated, the removable storage media 62 includes a computer usable storage medium having stored therein computer software and/or data.

In alternative embodiments, secondary memory 38 may include other similar devices for allowing computer programs or other instructions to be loaded into the computer system and for storing data. Such devices may include, for example, a removable storage unit 52 and an interface 54. Examples of such may include a program cartridge and cartridge interface (such as that found in video game devices), flash memory, a removable memory chip (such as an EPROM, EEPROM or PROM) and associated socket, and other removable storage units 52 and interfaces 54 which allow software and data to be transferred from the removable storage unit 52 to other devices.

The payment authorization server 14 may also include a communications interface 56. Communications interface 56 allows software and data to be transferred to external devices. Examples of communications interface 56 may include a modem, a network interface (such as an Ethernet card), a communications port, USB or firewire ports, a PCMCIA slot and card, wireless transceiver/antenna, etc. Software and data transferred via communications interface/module 56 may be, for example, electronic, electromagnetic, optical, or other signals capable of being received by communications interface 56. These signals are provided to communications interface 56 via the communications link (i.e., channel) 58. Communications link 58 carries signals and may be implemented using wire or cable, fiber optics, a phone line, a cellular phone link, an RF link, and/or other communications channels.

It is understood that the payment authorization server 14 may have more than one set of communication interfaces and communication links. For example, the payment authorization server 14 may have a communication interface/communication link pair to establish a communication zone for wireless communication, a second communication interface/communication link pair for low speed, e.g., WLAN, wireless communication, another communication interface/communication link pair for communication with low speed wireless networks, and still another communication interface/communication link pair for other communication.

Computer programs (also called computer control logic) are stored in main memory 44 and/or secondary memory 38. For example, computer programs are stored on disk storage, i.e. secondary memory 38, for execution by processor 34 via RAM, i.e. main memory 44. Computer programs may also be received via communications interface 56. Such computer programs, when executed, enable the method and system to perform the features of the present invention as discussed herein. In particular, the computer programs, when executed, enable processor 34 to perform the features of the corresponding method and system. Accordingly, such computer programs represent controllers of the corresponding device.

The payment authorization server 14 also includes a transmitter 60 and receiver 62 in communication with other components of the payment authorization server 14 (such as processor 34) via communication infrastructure 36, and may further be in communication with other devices through the network 18, such as the point of sale device 12 and/or the rewards account server 16.

The rewards account server 16 generally processes and stores information related to rewards accounts for one or more customers. Such information may include, for example, customer name and contact information (address, email, phone numbers, etc.), customer rewards account number, purchasing history, total purchase amount to date, spending habits, rewards earned, rewards availability, rewards coupons and offers, etc. The rewards account server 16 may be maintained or affiliated with a merchant 19 (as shown in FIG. 1) or alternatively be maintained or affiliated with a financial institution 32 (as shown in FIG. 2), and may have substantially the same construction and hardware components of the payment authorization server 14, as described above and illustrated in FIG. 4, yet function differently as described herein. The rewards account server may be in communication with the point of sale device 12 and/or the payment authorization server 14 through the communications network 18. In addition, though FIGS. 1 and 2 illustrate the database 17 stored on the payment authorization server 14, the database 17 may alternatively be stored and/or maintained on the rewards account server 16.

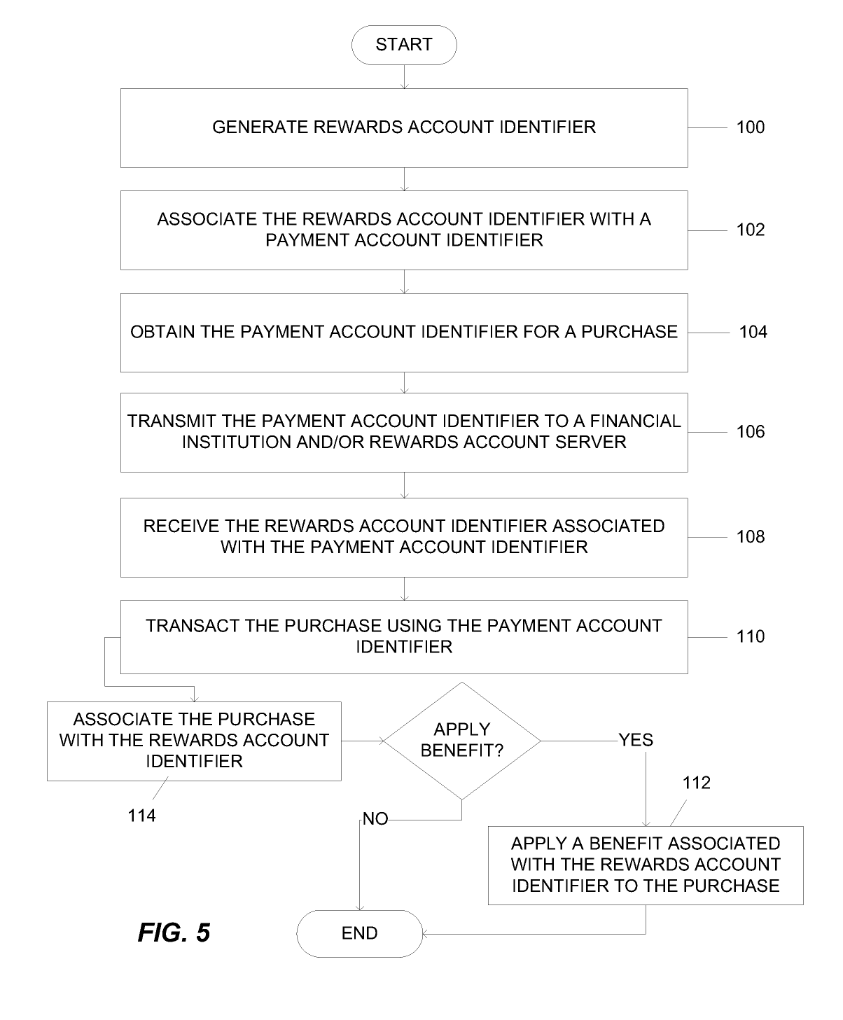

Now referring to FIG. 5, a flowchart of an exemplary method of processing a purchase, and in particular, of providing or retrieving “rewards” account information during a particular purchase or transaction is shown. A customer registers or signs up for a rewards account with a particular service or product provider, e.g., a merchant 19. To do so, a customer typically provides contact information to the merchant 19, and a rewards account identifier is issued that is unique to the customer for the customer to use during purchases to earn perks or bonuses for purchasing goods or services from the merchant 19 (Step 100).

The customer may also have a variety of existing preferred payment methods or accounts, including credit cards, debit cards, checks, etc. Each of these payment methods may have a unique payment account identifier, such as a credit card number, a debit card number, a checking or other bank account number, or the like. These payment account identifiers are provided by the financial institution 32 when an account is opened with that financial institution. A customer's rewards account identifier is associated with or linked to one or more of the customer's payment account identifiers issued from the financial institutions, and stored in the database 17 either on the payment authorization server 14 or the rewards account server 16 (Step 102). For example, The association or linkage may be achieved by the customer (or merchant) submitting the customer's rewards account identifier to the customer's financial institution to be associated with and stored along with the customer's payment account identifier (utilizing the payment authorization server 14, for example). Additional information may also be submitted and stored in association with the customer's payment account identifier, such as the name and address of the merchant that issued the rewards account identifier. Alternatively, the customer may provide one or more of their payment account identifiers to the merchant for the merchant to associate and store the payment account identifier with the rewards account identifier in the database 17, utilizing the rewards account server 16, for example.

Once the payment account identifier and rewards account identifier have been associated, the customer proceeds to purchase goods or services from the merchant. Once the desired goods or services have been selected, the merchant obtains or receives the payment account identifier that the customer elects to use to pay for the selected goods or services (Step 104). The payment account identifier may be obtained utilizing the point of sale device 12, which may facilitate obtaining the payment account identifier from a credit or debit card, receive an entered numerical account number via a keypad, through near field communications, or through a device providing the payment account identifier through a network, or the like.

Upon obtaining the payment account identifier, the payment account identifier is transmitted to both receive authorization from the financial institution that issued the payment account identifier and receive the rewards account identifier associated with the payment account identifier, if any (Steps 106, 108). For example, the point of sale device 12 may transmit the obtained payment account identifier to the payment authorization server 14 of the financial institution 32, where the database 17 may be stored. The point of sale device 12 may also transmit information regarding the goods or services being purchased, such as, for example, purchase price, a description of the goods or services purchased, a date of purchase, etc. The payment authorization server 14 retrieves the stored rewards account identifier that was previously associated with the customer's payment account identifier in the database 17, and also determines whether to authorize the transaction (e.g., does the customer have a sufficient balance, sufficient credit available, etc.). The payment authorization server 14 then transmits the rewards account identifier and payment authorization (or decline) to the point of sale device 12.

Alternatively, the point of sale device 12 may transmit the obtained payment account identifier to the payment authorization server 14 of the financial institution 32 for payment authorization, and also transmit the obtained payment account identifier to the rewards account server 16, which may be maintained by the merchant (as shown in FIG. 1) or a vendor for the merchant independent of the financial institution and contain the database 17. The rewards account server 16 retrieves the stored rewards account identifier that was previously associated with the customer's payment account identifier in database 17, and transmits the rewards account identifier associated with the payment account identifier to the point of sale device 12.

Upon receiving the rewards account identifier associated with the payment account identifier, the purchase is effected between the customer and the merchant (Step 110). In addition, any benefits presently available or associated with the rewards account identifier may be applied to the purchase or otherwise indicated as available through the point of sale device 12, for example (Step 112). Such benefits or perks may include monetary coupons, discounts on purchase price, free services or goods, or the like.

Further, information regarding the purchase may be attributed, logged or stored in association with the rewards account identifier (Step 114). For example, the point of sale device may transmit information regarding the sale, such as monetary amount, to the rewards account server 16 to be stored in association with the customer's rewards account identifier in the database 17 (or another database that logs or tracks purchasing history). Typical rewards accounts track accumulated “points” that correspond to total purchased amount, and then provide discount or rewards tiered to the total amount of points accumulated. Of note, the rewards account server 16 and information regarding purchases or accumulated rewards may be maintained by the merchant (as shown in FIG. 1) or the financial institution (as shown in FIG. 2).

The present invention can be realized in hardware, or a combination of hardware and software. Any kind of computing system, or other apparatus adapted for carrying out the methods described herein, is suited to perform the functions described herein. A typical combination of hardware and software could be a specialized computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language or notation, of a set of instructions intended to cause a system having an information processing capability to perform a particular function either directly or after either or both of the following a) conversion to another language, code or notation; b) reproduction in a different material form.

It will be appreciated by persons skilled in the art that the present invention is not limited to what has been particularly shown and described herein above. In addition, unless mention was made above to the contrary, it should be noted that all of the accompanying drawings are not to scale. Moreover, though different features may have been discussed herein with reference to specific features, it is understood that such features and figures are not necessarily mutually exclusive of each other and may be combined in a variety of different ways. A variety of modifications and variations are possible in light of the above teachings without departing from the scope and spirit of the invention, which is limited only by the following claims.

What is claimed is:

1. A method of processing a purchase, comprising:
obtaining a payment account identifier for a purchase;
transmitting the payment account identifier to a database;
receiving a rewards account identifier associated with the payment account identifier from the database; and
transacting the purchase using the payment account identifier.

2. The method of claim 1, wherein the rewards account identifier is received from the financial institution.

3. The method of claim 1, wherein the rewards account identifier is received from a merchant.

4. The method of claim 1, further comprising associating the purchase with the rewards account identifier.

5. The method of claim 4, wherein associating the purchase with the rewards account identifier includes attributing a monetary amount of the purchase to the rewards account identifier.

6. The method of claim 1, further comprising applying a benefit associated with the rewards account identifier to the purchase.

7. The method of claim 6, wherein the benefit includes at least one of a monetary discount and at least one of a free good and service.

8. The method of claim 1, further comprising:
submitting the rewards account identifier to the financial institution; and
associating the rewards account identifier with the payment account identifier.

9. The method of claim 8, wherein submission of the rewards account identifier to the financial institution originates from a merchant.

10. The method of claim 1, further comprising submitting a plurality of rewards account identifiers to the financial institution for association with the payment account identifier.

11. The method of claim 1, wherein the payment account identifier is obtained at a point of sale.

12. A purchase processing system, comprising:
a point of sale device, the point of sale device having a processor configured to:
receive a payment account identifier for a purchase;
cause the payment account to be transmitted;
receive a rewards account identifier associated with the payment account; and
transact the purchase using the payment account identifier and the rewards account identifier.

13. The system of claim 12, further comprising a rewards account server in communication with the point of sale device, wherein the point of sale device is configured to transmit purchase information in connection with the purchase and the rewards account identifier to the rewards account server.

14. The system of claim 13, wherein the rewards account server is configured to store the purchase information in association with the rewards account identifier.

15. The system of claim 12, further comprising a payment authorization server in communication with the point of sale device, the point of sale device being configured to transmit purchase information corresponding to the purchase and the rewards account identifier to the payment authorization server.

16. The system of claim 12, further including a database, the database containing the rewards account identifier associated with the payment account identifier.

17. The system of claim 12, wherein the point of sale device is further configured to apply a benefit associated with the rewards account identifier to the purchase.

18. The system of claim 17, wherein the benefit includes at least one of (a) a monetary discount and (2) indicating the availability of one of a free good and service.

19. A computer, comprising:
a storage device; and
a database stored in the storage device, the database containing a rewards account identifier associated with a payment account identifier.

20. The computer of claim 19, wherein the database further contains purchase information associated with the rewards account identifier.

21. The computer of claim 19, further comprising:
a communication interface in communication with the storage device; and
a processor in communication with the storage device and communication interface, processor configured to obtain a rewards account identifier associated with a corresponding payment account identifier from the database, the communication interface configured to transmit the rewards account identifier.
